(19) United States
(12) Patent Application Publication
(10) Pub. No.: US 2009/0158899 A1
(43) Pub. Date: Jun. 25, 2009

(54) COMBINED CARBINER CLIP AND BOTTLE OPENER

(76) Inventor: Kenneth D. Eisenbraun, Bloomfield Village, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/960,782

(22) Filed: Dec. 20, 2007

(51) Int. Cl. B67B 7/44; A44B 13/00

(52) U.S. Cl. 81/3.09; 24/599.1

(57) ABSTRACT

A device which functions as both a bottle opener and carabiner. The device being a triangular structure having a pivotable segment disposed on one side of the structure, and a lip extending inwardly disposed either of the two remaining sides. The pivotable segment can be manually moved from a closed position to an open position and is urged back into a closed position by a biasing means. A portion of the device is placed on top of the cap of a bottle with the lip positioned underneath the cap such that a user can urge the cap out of engagement with the bottle by applying a downward force to the device. The device can also be used to secure an auxiliary device therein by moving the pivotable segment to an open position and inserting a leg of the device through an opening in the auxiliary, and then closing the pivotable segment.

### CROSS REFERENCE TO RELATED APPLICATION

This application claims the benefit of application Ser. No. 60/882,276 filed Dec. 28, 2006.

### BACKGROUND OF THE INVENTION

1. Field of the Invention

The invention relates to a device functioning as a combination of a carabiner clip which allows the bottle opener to be retained to an auxiliary device such as a belt, belt loop, a portable phone, a key chain, or the like; and a bottle top opener of the type used for beer bottles, soda pop bottles or the like having a capped top.

2. Description of the Prior Art

Conventional carabiners of the type to which the present invention relates have a looped body with a gap disposed therein, and a pivotable segment disposed with the gap to close the loop. Accordingly, the looped body has two free ends spaced apart and directed towards each other. A stopping member is fixed to one of the free ends and the pivotable segment is pivotable attached to the other free end. The pivotable segment can move between a closed position and an open position. In the closed position, the pivotable segment closes the loop and in the open position, the pivotable segment opens the loop. A biasing means works in concert with the stopping member to retain the pivotable section in a closed position.

Conventional bottle openers of the kind to which the present invention relates have a triangular structure surrounding an enclosed space. The triangular structure has a lip that engages the bottle cap. The triangular structure removes a cap off of a capped bottle by seating the lip underneath the bottle cap's edge, and resting a portion of the triangular structure on the exposed surface of the cap. The cap acts as fulcrum and translates a downward force applied on the non-engaged portion of the triangular structure to an upward force on the lip to eject the bottle cap from the bottle. However, none of the bottle openers of the conventional art provide a pivoting segment with which to secure the bottle opener to an auxiliary structure.

### SUMMARY OF THE INVENTION AND ADVANTAGES

According to one aspect of the invention, a device having a triangular structure is provided for removing a cap off a capped bottle while having the ability to retain an object within the triangular structure. The triangular structure has two sides formed by a first rod rigidly connected to a second rod to form an interior acute angle. A third side is formed by third and fourth rods, the third and fourth rods are each rigidly joined at one of their ends to the free ends of both the first and second rod leaving a gap in the triangular structure. A fifth rod is pivotable attached to the free end of either the third or fourth rod, the fifth rod having a length substantially equal to the gap. The fifth rod is a pivotable segment of the device and is movable between first and second positions, the first position closing the triangular structure and the second position opening the triangular structure. An inwardly extending lip is affixed on either the first or second rod allowing the lip and the triangular structure to interact with a capped bottle to remove the cap. Thus a user is able to use the device to open bottles as well as retain an auxiliary device thereto.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of the combined clip and bottle opener of the present invention showing the pivoting segment moving from a closed position to an open position;

FIG. 2 is an expanded broken-away view of the hinge assembly that supports the pivoting segment;

FIG. 3 is a perspective view of an alternate form of the combined clip and bottle opener of the present invention in a closed configuration wherein the pivoting segment pivots outwardly from the enclosed perimeter, and having a key chain secured within the triangular structure;

FIG. 4 is a sectional view through the device of the present invention being used to open a bottle cap.

### DETAILED DESCRIPTION OF THE INVENTION

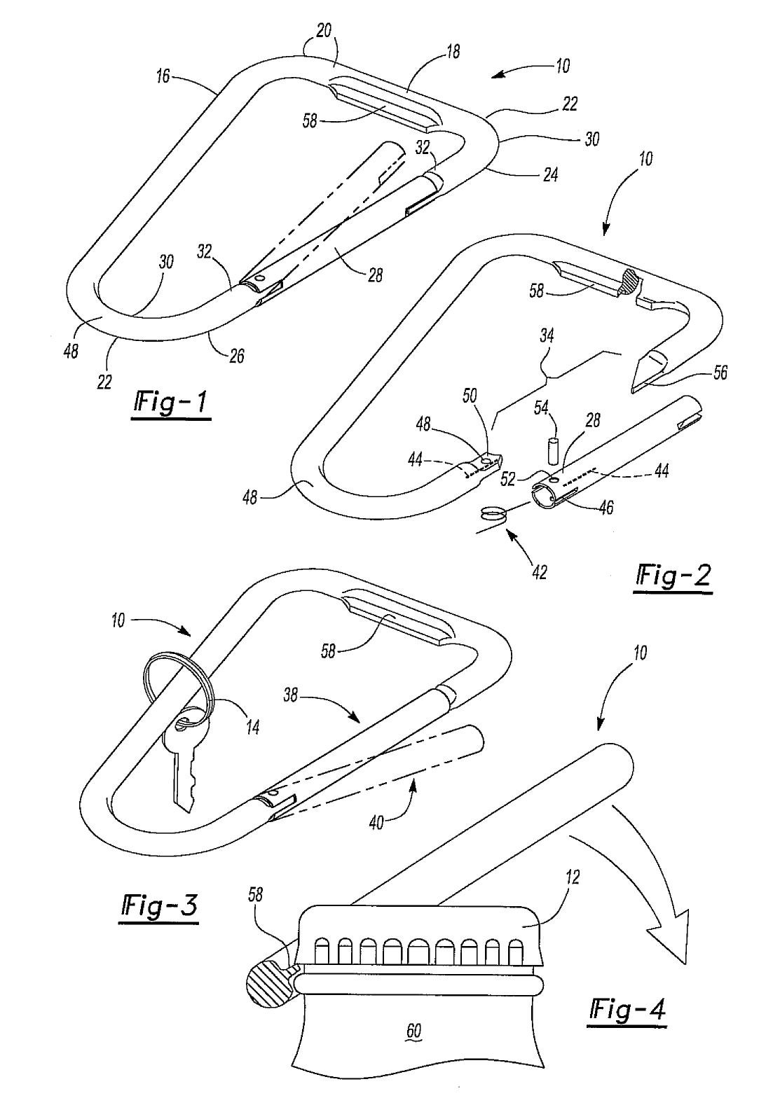

With reference first to FIG. 1, a preferred embodiment of a device 10 for removing a bottle cap 12 and securing an auxiliary device 14 to said device 10 according to the present invention is illustrated. The device 10 has a triangular structure with two sides formed by first and second rods 16 and 18 rigidly joined together at a first end 20 of each rod to form an interior acute angle. The first and second rods 16 and 18 each have second ends 22 which are spaced apart and opposite the first ends 20. The third side of the triangular structure is formed by three parts, third, fourth, and fifth rods 24, 26, and 28. The rods 16, 18, 24, 26, and 28 are formed of a rigid material such as hardened plastic or a metal such as steel. The third and fourth rods 24 and 26 each having joining ends 30 spaced apart and opposite their free ends 32. The joining ends 30 of the third and fourth rod 24 and 26 are each rigidly joined to the second ends 22 of the first and second rod 16 and 18, and form interior acute angles. The combined lengths of the third and fourth rods 24 and 26 are less than the distance between the second ends 22 of the first and second rods 16, 18, and thus a gap 34 is left between the free ends 32 of the third and fourth rods 24 and 26. It is anticipated that the first, second, third, and fourth rods 16, 18, 24, and 26 can be stamped or molded as one piece, or can be separate pieces fitted together.

The fifth rod 28 has a length substantially equal to the gap 34, and is pivotable disposed within the gap 34. The fifth rod 28 has a mating end 36 that is pivotably attached to the free end 32 of either of the fourth or third rod 26 or 24 and can move between a first closed position 38 and a second open position 40. Thus the fifth rod 28 is a pivotable segment disposed within the gap 34, and can pivot at its connection to either the third or fourth section. In the first position, the fifth rod 28 lies substantially parallel to the third and fourth rods 24 and 26 and closes the triangular structure in which the fifth rod 28 is disposed. In the second position the fifth rod 28 lies at an angle to the third and fourth rods 24 and 26 and opens the triangular structure to allow the insertion or removal of an auxiliary device 14 such as a key chain, or belt loop.

A biasing means 42 is disposed in the device 10. The biasing means 42 shown in FIG. 2 is a coil of wire having two spring legs extending oppositely from each other. The biasing means 42 is placed where the fifth rod 28 pivots about with each spring leg being inserted into a tubular recess 44, and urges the fifth rod 28 into the first closed position 38. The mating end 36 of the fifth rod 28 has a slot 46 disposed therein, the slot 46 extends lengthwise from the mating end 36 towards the free end 32. A first aperture 48 is disposed at the mating end 36 and extends transversally through the mating end 36. A male member 50 is provided where the fifth rod 28 is pivotably secured to. The male member 50 has a second aperture 52 extending transversally therethrough. The male member 50 is secured to the mating end 36 by inserting the male member 50 into the slot 46 until the first aperture 48 aligns with the second aperture 52 and inserting a retaining pin 54 therein. FIGS. 1-3 show a stopping member 56 fixed at the free end 32 of the third rod 24 and opposite the male member 50; accordingly, if the fifth rod 28 pivots about the third rod 24, the stopping member 56 will be disposed on the free end 32 of the fourth member.

A lip 58 is affixed between the first end 20 and the second end 22 of either the first or second rods 16 or 18, and is directed toward the interior of the triangular structure allowing the lip 58 and the triangular structure to interact with a capped bottle 60 in order to remove the cap. The lip 58 must be rigid enough to force the cap off the bottle 60, and can be made of a metal such as steel. Thus a device 10 is provided that can remove a cap off of a capped bottle 60 and can retain an auxiliary device 14 such as a key chain or a belt loop.

Obviously, many modifications and variations of the present invention are possible in light of the above teachings and may be practiced otherwise than as specifically described while within the scope of the appended claims.

What is claimed is:

1. A device having a triangular structure functioning as a combination carabiner and bottle top opener comprising:
two sides formed of a first and a second rod rigidly joined together at a first end of each rod to form an interior acute angle, said first and second rods each also having a second end spaced apart and opposite said first end;
a third side formed by a third and fourth rod, said third and fourth rod each having a joining end spaced apart and opposite a free end, said joining ends each rigidly joined to said second ends to form interior acute angles; the combined lengths of said third and fourth rods being less than the distance between said second ends of said first and second rods, leaving a gap between said free ends of said third and fourth rods;
a fifth rod having a length substantially equal to said gap, said fifth rod having a mating end, said mating end pivotably attached to said free end of either of said fourth or third rod, said fifth rod being movable between a first position in which said fifth rod lies substantially parallel to said third and fourth rods and closes the triangular structure in which said fifth rod is disposed, and a second position in which said fifth rod lies angular to said third and fourth rods and opens the triangular structure to allow the insertion or removal of a connecting device; and
a lip affixed between said first end and said second end of either said first or second rods, and directed toward the interior of the triangular structure allowing the lip and the triangular structure to interact with a capped bottle to remove the cap.

2. A device as set forth in claim 1 further comprising a biasing means, said biasing means disposed at said mating end and urging said fifth rod to said first position.

3. A device as set forth in claim 2 further comprising a stopping member, said stopping member disposed opposite said mating end and affixed at either of said third or fourth rod, said stopping member working in concert with said biasing means to retain said fifth rod in said first position.

4. A device as set forth in claim 1 wherein said fifth rod further comprises a slot disposed at said mating end, and a first aperture extending transversally through said first end.

5. A device as set forth in claim 4 further comprising a male member disposed opposite a stopping member and both being affixed at either of said third or fourth rod, said male member having a second aperture extending transversally therethrough.

6. A device as set forth in claim 5 further comprising a retaining pin, said retaining pin pivotably securing said male member to said slot.
